(19) United States
(12) Patent Application Publication
(10) Pub. No.: US 2024/0372285 A1
(43) Pub. Date: Nov. 7, 2024

(54) Connecting Terminal Fixing Structure

(71) Applicant: K.S. TERMINALS INC., CHANGHUA COUNTY (TW)

(72) Inventor: Chun Wei Yang, CHANGHUA COUNTY (TW)

(21) Appl. No.: 18/534,156

(22) Filed: Dec. 8, 2023

(30) Foreign Application Priority Data
May 5, 2023 (TW) 112204329

(51) Int. Cl. H01R 13/42; H01R 13/506; H01R 13/621; H01R 13/627

(52) U.S. Cl. CPC H01R 13/42; H01R 13/506; H01R 13/621; H01R 13/627

(57) ABSTRACT

A connecting terminal fixing structure comprising: a conductive seat, a clamping member, and a nut; the conductive seat consisting of two side plates and a top plate that are integrally formed, the top plate being connected to the top of the side plate on each side so that the conductive seat forms an n-shape, and the top plate having a perforation; the clamping member having an opening, the clamping member being located on the lower surface of the top plate and at least one snap-fitting part extending from each of the opposite sides of the clamping member; the nut having a threaded hole; wherein, said perforation, said opening, and said threaded hole being correspondingly positioned to form a through hole, facilitating the swift assembly of the terminal.

### FIELD OF THE INVENTION

The present disclosure relates to an electrical connection technology, specifically, the present disclosure can quickly position and fix a terminal on a conductive terminal after the printed circuit board (PCB) with the conductive terminal is inserted.

### BACKGROUND OF THE INVENTION

The connecting terminal is a basic component used for power transmission or electronic signal transmission within the electronic system. In order to enable the terminal to be stably fixed to the conductive terminal on the PCB during the production process by introducing an automatic fastening screw system, and to ensure that the terminal does not become detached from the conductive terminal on the PCB during transportation, it is common to use a bolt to fasten the terminal to the conductive terminal. However, it is not only difficult to quickly align the bolt hole between the terminal and the conductive terminal, but also may cause the problem of the bolt loosening after being fastened due to the transportation vibration, which may cause the terminal and the conductive terminal to displace from each other, losing the function of electricity transmission.

Therefore, how to quickly align the bolt hole of the terminal and the conductive terminal, and prevent the bolt from loosening during transportation, while maintaining a second protective layer that fixes the terminal and the conductive terminal to contact and connect with each other, enabling the connecting terminal not to lose its main function of connecting and transmitting electricity, is an urgent problem to be solved in this field.

### SUMMARY OF THE INVENTION

Based on the above, the purpose of the present disclosure is to provide a fixing structure of the connecting terminal which is easy to manufacture, convenient to assemble and has a dual quick-locking function enabling the quick and stable fixing connection of the terminal and the conductive terminal.

In order to achieve the above and other purposes, the present disclosure provides a connecting terminal fixing structure, comprising: a conductive seat, a clamping member, and a nut; the conductive seat consisting of two side plates and a top plate that are integrally formed, the top plate being connected to the top of the side plate on each side so that the conductive seat forms an n-shape, and the top plate having a perforation; the clamping member having an opening and being located on the lower surface of the top plate, and the clamping member extending at least one snap-fitting part from each of the two opposite sides; the nut having a threaded hole; wherein said perforation, said opening, and said threaded hole are positioned correspondingly to form a through hole.

Wherein, the snap-fitting part is an elastic piece positioned to correspond to at least one notch of a terminal, and the elastic piece is clamped and connected to the notch.

Wherein, the elastic piece has a protruding limiter, and the protruding limiter protrudes into the notch.

Wherein, the surface of the notch is an inclined surface.

Wherein, the elastic piece has a guiding surface located at its open end.

Wherein, the side plate has at least one inclined part near the top plate, the inclined part is inclined toward the opposite side plate, and the upper end of the inclined part is held against the lower surface of the clamping member.

Wherein, at least one projection part extends from each of the other two opposite sides of the clamping member.

Wherein, the projection part is fixed against the junction of the top plate and the side plate.

Wherein, a terminal is provided above the top plate, and a flat part of the terminal has a connection hole corresponding to the position of the through hole.

Wherein, the clamping member and the nut are integrally formed.

### BRIEF DESCRIPTION OF THE DRAWINGS

FIG. 1 is a three-dimensional view of the first embodiment provided by the present disclosure.

FIG. 2 is a schematic exploded view of the first embodiment provided by the present disclosure.

FIG. 3 is a three-dimensional view of the second embodiment provided by the present disclosure.

FIG. 4 is a schematic exploded view of the second embodiment provided by the present disclosure.

FIG. 5 is a three-dimensional view of the third embodiment provided by the present disclosure.

FIG. 6 is a schematic exploded view of the third embodiment provided by the present disclosure.

FIG. 7 is a three-dimensional view of the fourth embodiment provided by the present disclosure.

FIG. 8 is a schematic exploded view of the fourth embodiment provided by the present disclosure.

FIG. 9 is a three-dimensional view of the fifth embodiment provided by the present disclosure.

FIG. 10 is a schematic exploded view of the fifth embodiment provided by the present disclosure.

### DESCRIPTION OF THE PREFERRED EMBODIMENTS

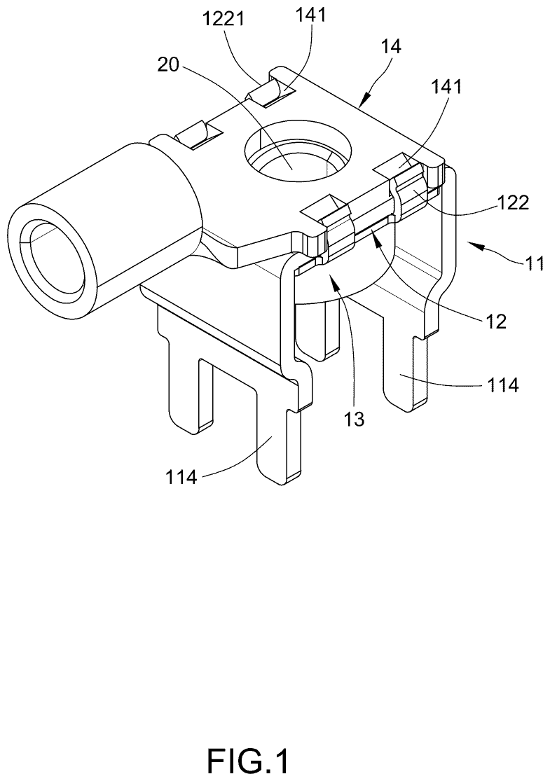

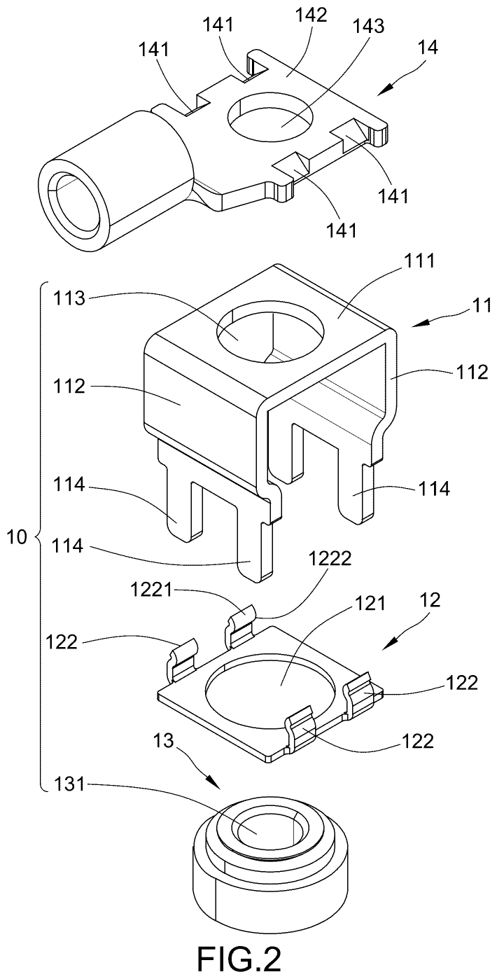

Referring to FIGS. 1 to 2, which illustrate the first embodiment of the connecting terminal fixing structure of the present disclosure, the connecting terminal fixing structure 10 comprises: a conductive seat 11, a clamping member 12, and a nut 13; the conductive seat 11 consisting of two side plates 112 and a top plate 111 that are integrally formed, the top plate 111 being connected to the top of the side plate 112 on each side so that the conductive seat 11 forms an n-shape, and the top plate 111 having a perforation 113; the clamping member 12 having an opening 121 and being located on the lower surface of the top plate 111, the clamping member 12 having two snap-fitting parts 122 extending from each of the two opposite sides; the nut 13 having a threaded hole 131 whose inner wall is provided with a thread; wherein the perforation 113, the opening 121, and the threaded hole 131 are positioned correspondingly to form a through hole 20; wherein the snap-fitting part 122 is contacted and connected to a terminal 14 above the top plate 112.

The clamping member 12 is located on the lower surface of the top plate 111, and the snap-fitting parts 122 on two opposite sides of the clamping member 12 extend to both sides of the top plate 111 above.

The snap-fitting part 122 is an elastic piece 122, and the position of the elastic piece 122 corresponds to the position of a notch 141 in a flat part 142 of the terminal 14, and the number of the elastic pieces 122 and the notches 141 are the same.

The elastic piece 122 has a guiding surface 1221 and a protruding limit part 1222, the guiding surface 1221 is provided at the open end of the elastic piece 122 and is located above the outer edge of the terminal 14, the protruding limit part 1222 protrudes into the notch 141 and contacts with the surface of the notch 141, and the surface of the notch 141 is an inclined surface.

By using the guiding surface 1221, the terminal 14 can smoothly slide into between the opposite sides of the elastic piece 122 and be snapped at the position of the protruding limit part 1222 so that the surface of the notch 141 of the terminal 14 can contact the protruding limit part 1222, thereby enabling the terminal 14 to be limited and fixed, so that the flat part 142 of the terminal 14 is closely connected to the conductive seat 11, and the connection hole 143 on the terminal 14 is also aligned with the through hole 20, so that the screw can be used to quickly lock the terminal 14 and the conductive seat 11 through the connection hole 143 and the through hole 20, thereby enabling the terminal 14 to be connected to the conductive seat 11 as a second layer of locking measures.

The bottom of each side plate 112 has at least one pin 114, so that the conductive seat 11 can be inserted on the PCB, in this embodiment, each side plate 112 has two pins 114.

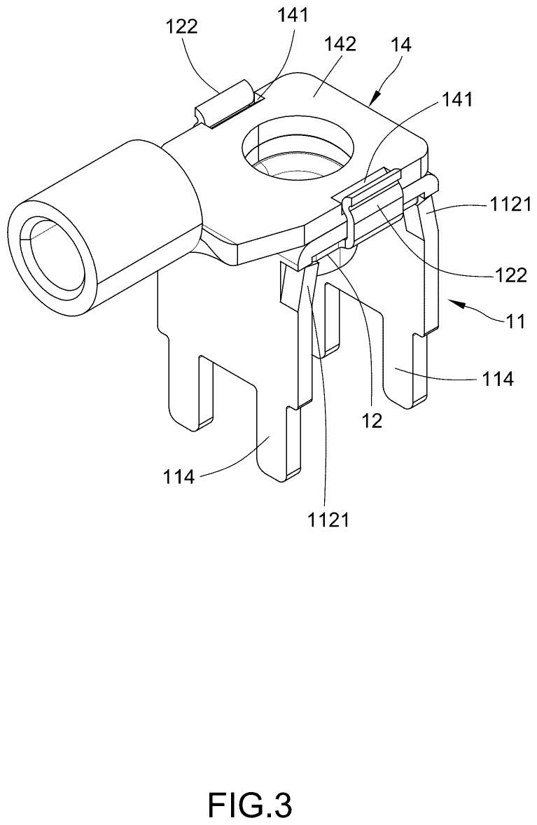

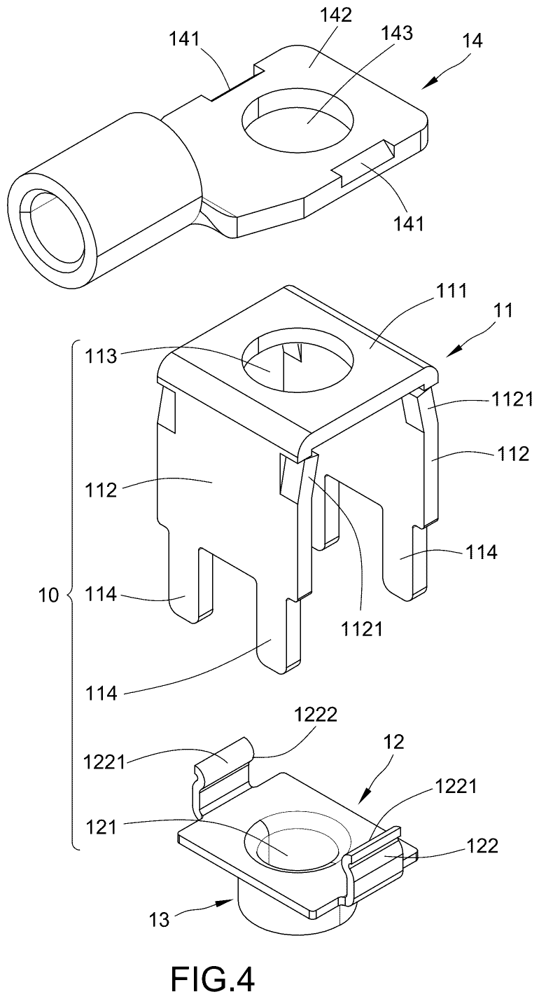

Referring to FIGS. 3 to 4, which illustrate the second embodiment of the connecting terminal fixing structure 10 of the present disclosure, in this embodiment, the clamping member 12 has an elastic piece 122 extending from each of two opposite sides, and each elastic piece 122 clamps to a notch 141 on each side of the terminal 14.

The side plate 112 has at least one inclined part 1121 near the top plate 111. In this embodiment, one side plate 112 has two inclined parts 1121, the inclined part 1121 is inclined toward the opposite side plate 112, and the upper end of the inclined part 1121 is against the lower surface of the clamping member 12. Therefore, when the clamping member 12 is placed on the lower surface of the top plate 111, the inclined part 1121 can be held against the lower surface of the clamping member 12, so that the clamping member 12 can be fixed more closely to the lower surface of the top plate 111 and would not easily fall off due to the gravity.

The clamping member 12 and the nut 13 are integrally formed, so that one assembly process can be reduced.

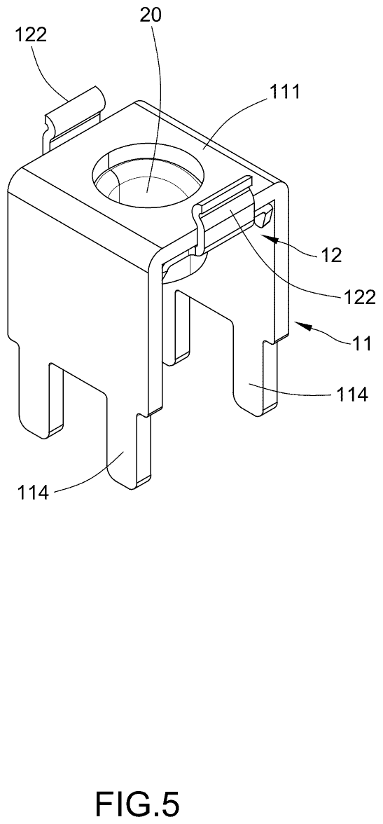

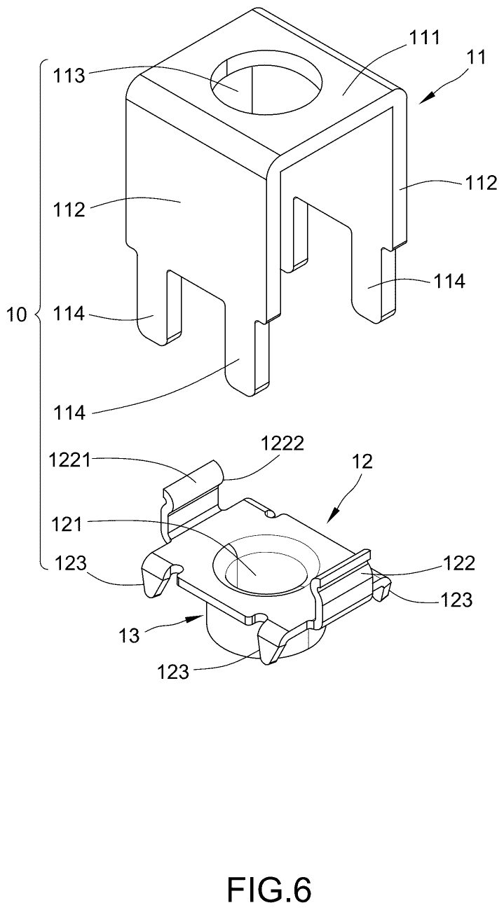

Referring to FIGS. 5 to 6, which illustrate the third embodiment of the connecting terminal fixing structure 10 of the present disclosure, wherein at least one projection part 123 extends from each of the two opposite sides of the clamping member 12, in this embodiment, two projection parts 123 extend from each of the two opposite sides of the clamping member 12, when the clamping member 12 is placed on the lower surface of the top plate 111, the projection part 123 contacts the junction of the top plate 111 and the side plate 112 so that the clamping member 12 is closely fixed to the lower surface of the top plate 111 and is difficult to be moved, thereby strengthening the joint stability between the clamping member 12 and the conductive seat 11.

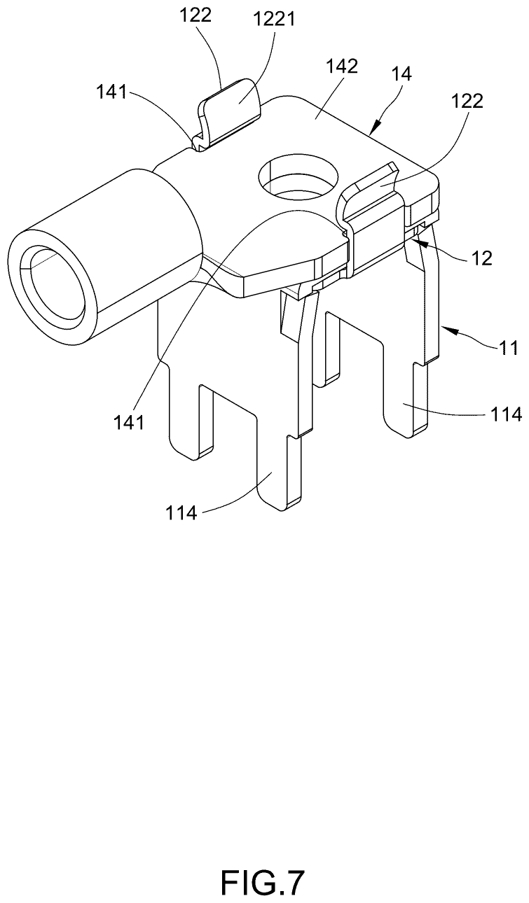

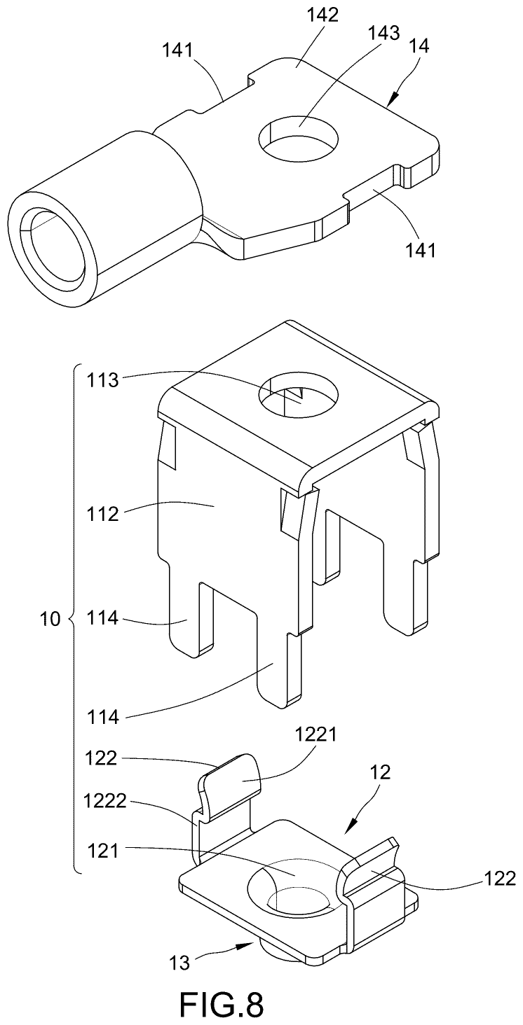

Referring to FIGS. 7 to 8, which illustrate the fourth embodiment of the connecting terminal fixing structure 10 of the present disclosure, in this embodiment, the notch 141 of the terminal 14 is an inner concave rectangle, and the protruding limiter 1222 of the elastic piece 122 clamps with the notch 141 in a large area to enhance the tightness of the elastic piece 122 clamping the terminal 14.

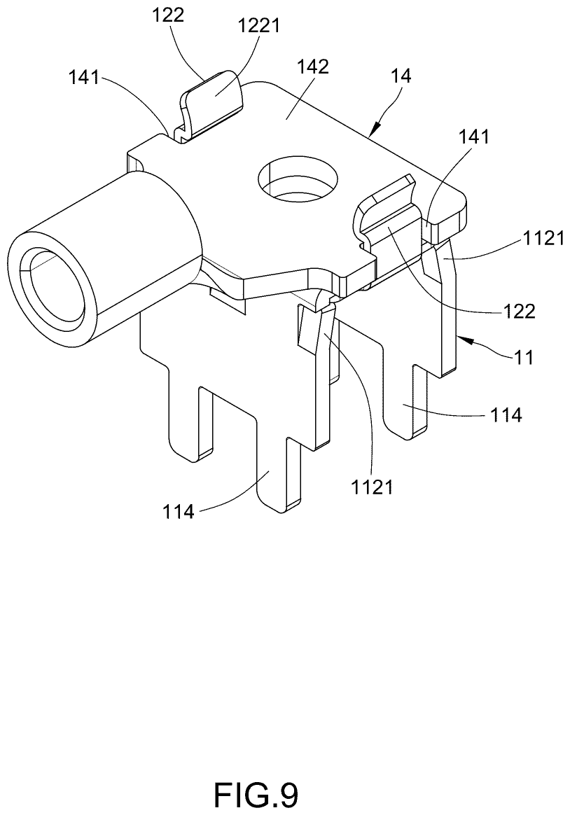

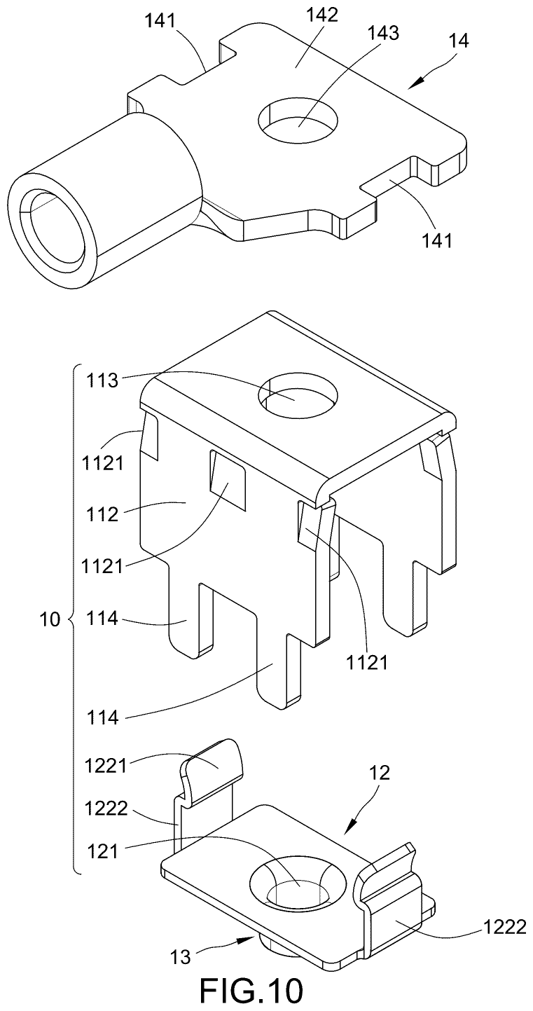

Referring to FIGS. 9 to 10, which illustrate the fifth embodiment of the connecting terminal fixing structure 10 of the present disclosure, in this embodiment, one side plate 112 has three inclined parts 1121 which are inclined toward the opposite side plate 112, and more inclined parts 1121 can hold the clamping member 12 more securely without moving or falling off due to gravity when the clamping member 12 is placed on the lower surface of the top plate 111.

Through the technical solution provided by the present disclosure, the conductive seat 11 on the PCB can be quickly aligned with the position of the terminal 14 and securely connected to the positioning screw hole, thereby reducing the assembly time and material used, and achieving optimal contact performance and reliability over a large area. In addition, due to the design of the clamping member 12 which strengthens the tightness of the clamping member 12 against the conductive seat 11, and also due to the snap-fitting part 122 of the clamping member 12, the conductive seat 11 and the terminal 14 are not only fastened by bolts, but the clamping member 12 also provides a second layer of tight clamping mechanism which prevents the problem of the displacement between the conductive seat 11 and the terminal 14 due to loosening by vibration during transportation.

1. A connecting terminal fixing structure, comprising:
a conductive seat, a clamping member, and a nut;
the conductive seat consisting of two side plates and a top plate that are integrally formed, the top plate being connected to the top of the side plate on each side so that the conductive seat forms an n-shape, and the top plate having a perforation;
the clamping member having an opening and being located on the lower surface of the top plate, and the clamping member extending at least one snap-fitting part from each of the two opposite sides; and
the nut having a threaded hole;
wherein, the perforation, the opening, and the threaded hole are positioned correspondingly to form a through hole.

2. The connecting terminal fixing structure according to claim 1, wherein the snap-fitting part is an elastic piece positioned to correspond to at least one notch of a terminal, and the elastic piece is clamped and connected to the notch.

3. The connecting terminal fixing structure according to claim 2, wherein the elastic piece has a protruding limiter, and the protruding limiter protrudes into the notch.

4. The connecting terminal fixing structure according to claim 2, wherein the surface of the notch is an inclined surface.

5. The connecting terminal fixing structure according to claim 2, wherein the elastic piece has a guiding surface located at its open end.

6. The connecting terminal fixing structure according to claim 1, wherein the side plate has at least one inclined part near the top plate, the inclined part is inclined toward the opposite side plate, and the upper end of the inclined part is held against the lower surface of the clamping member.

7. The connecting terminal fixing structure according to claim 1, wherein at least one projection part extends from each of the other two opposite sides of the clamping member.

8. The connecting terminal fixing structure according to claim 7, wherein the projection part is fixed against the junction of the top plate and the side plate.

9. The connecting terminal fixing structure according to claim 1, wherein a terminal is provided above the top plate, and a flat part of the terminal has a connection hole corresponding to the position of the through hole.

10. The connecting terminal fixing structure according to claim 1, wherein the clamping member and the nut are integrally formed.
